(19) United States
(12) Patent Application Publication
(10) Pub. No.: US 2025/0266215 A1
(43) Pub. Date: Aug. 21, 2025

(54) LOW VOLTAGE CONTACT GROUP

(71) Applicant: ABB S.p.A, Milano (IT)

(72) Inventors: Roberto Rota Martir, Brembate Sopra (BG) (IT); Nicola Bresciani, Bergamo (IT)

(21) Appl. No.: 19/045,901

(22) Filed: Feb. 5, 2025

(30) Foreign Application Priority Data
Feb. 20, 2024 (EP) 24158529.8

(51) Int. Cl. H01H 1/22

(52) U.S. Cl. CPC H01H 1/221

(57) ABSTRACT

A low-voltage contacts group for a low-voltage circuit breaker is disclosed. The low-voltage contacts group comprises: a fixed contact adapted to be electrically connected to an electrical terminal of said circuit breaker; and a movable contact assembly. The movable contact assembly comprises a rotating supporting shaft adapted to be operatively connected to an actuation mechanism of said circuit breaker and which has a body provided with a first seat; and a rotating moving contact sub-assembly. The rotating moving contact sub-assembly comprises a supporting structure, a rotating moving contact connected to the supporting structure, an elastic element for ensuring adequate contact pressure when an active surface of the moving contact is coupled to the fixed contact, and a mechanical link between the elastic element and supporting structure.

### CROSS-REFERENCE TO RELATED APPLICATIONS

The present application claims priority to European Patent Application No. 24158529.8 filed on Feb. 20, 2024, and titled “LOW VOLTAGE CONTACT GROUP”, which is hereby incorporated by reference in its entirety.

### TECHNICAL FIELD

The present disclosure relates to a low voltage contact group for a low voltage switching device, and in particular for a low voltage circuit breaker. More in particular, the present disclosure relates to a low voltage contact group provided with a rotating movable contact with optimized performances in case of contacts opening due to repulsion forces under, e.g., short circuit conditions.

### BACKGROUND

It is known that in the low voltage field, the switching devices, and in particular the circuit breakers, are generally provided with a contact assembly comprising a movable contact and a fixed contact that can be coupled to and uncoupled from one another. The low voltage switching devices of the known art also comprise actuating means that cause relative movement of said movable contact with respect to the fixed contact, so that they can assume at least one first, coupling, position (closed position—circuit closed) and one second, separation, position (open position—circuit open).

It is known in the low voltage field that for certain applications it is desirable to have an adequate contact pressure between the movable contact and the fixed contact when they are in the closed position. To this purpose, the contact assembly can be generally provided with a system normally constituted by one or more springs which act on the movable contact and keep it pressed against the fixed contact.

It is also known that under, e.g., short circuit conditions, electrodynamic repulsion forces occur between the contacts. These repulsion forces generate a useful thrust that helps increasing the separation speed of the moving contacts with respect to the fixed contacts so that the intervention time is reduced and the presumed short-circuit current is prevented from reaching its maximum value.

A critical aspect in this case is due to the fact that the electrodynamic repulsion forces—despite positively contributing to the contacts separation—provide the moving contact with high speeds and a great energy at the end of its stroke, thereby possibly provoking violent impacts of the movable contact assembly against the casing of the circuit breaker and possibly causing the bouncing of the moving contact toward the fixed contact.

Several solutions have been proposed in order to properly control the contact pressure in the closed position and the opening speed and energy of the movable contact during repulsion under, e.g., short circuit conditions. For example, the use of relatively complicated latching systems has been proposed to avoid bouncing of the movable contact and latching it in the open position; or the use of a movable contact assembly in which the movable contact body as a particular profile, so that the torque generated by a pressing spring may change in intensity and direction during rotation of the moving contact, and similar solutions.

However, the known solutions are not completely satisfactory for a number of reasons, including, for example, the mechanical complexity and/or the number of components needed, the presence of friction phenomena which may cause wearing of the movable contact body, and similar problems.

On the basis of the above considerations, there is clearly a need to have available alternative technical solutions that will enable the limits and the problems set forth above to be overcome. Hence, the present disclosure is aimed at providing a low voltage contacts group, in particular a low voltage contacts group for a low voltage circuit breaker, which allows overcoming at least some of the above-mentioned shortcomings.

### BRIEF DESCRIPTION

In particular, the present disclosure is aimed at providing a low voltage contacts group, in particular for a low voltage circuit breaker, with improved performances in case of contacts opening due to repulsion forces under, e.g., short circuit conditions.

Furthermore, the present disclosure is aimed at providing a low voltage contacts group, in particular for a low voltage circuit breaker, which allows avoiding-or at least minimizing-friction problems during opening due to electrodynamic repulsion forces between the fixed and movable contacts.

Moreover, the present disclosure is aimed at providing a low voltage contacts group, in particular for a low voltage circuit breaker, which has a compact structure.

Furthermore, the present disclosure is aimed at providing a low voltage contacts group, in particular for a low voltage circuit breaker, which is able to guarantee an adequate contact pressure between the fixed and movable contacts in the closed position without hindering the movement of the movable contact during opening due to electrodynamic repulsion forces between the fixed and movable contacts under, e.g., short circuit conditions.

Moreover, the present disclosure is aimed at providing a low voltage contacts group, in particular for a low voltage circuit breaker, in which the possibility that under short circuit conditions the movable contact bounces back toward the fixed contact is avoided, or at least minimized.

Furthermore, the present disclosure is aimed at providing a low voltage contacts group, in which the number of components is minimized.

Also, the present disclosure is aimed at providing a low voltage contacts group, which is reliable and relatively easy to be manufactured and at competitive costs.

The above aim and purposes, as well as other purposes that will emerge clearly from the following description and attached drawings, are provided, according to the present disclosure, by a low-voltage contacts group for a low-voltage circuit breaker.

In a further aspect, the present disclosure also relates to a low-voltage circuit breaker, in particular a Molded Case Circuit Breaker, comprising a low voltage contacts group as described herein.

In a general definition of the present disclosure, the low-voltage contacts group for a low-voltage circuit breaker is characterized in that it comprises a fixed contact adapted to be electrically connected to an electrical terminal of said circuit breaker; a movable contact assembly comprising a rotating supporting shaft adapted to be operatively connected to an actuation mechanism of said circuit breaker and which has a body provided with a first seat; a rotating moving contact sub-assembly comprising a supporting structure positioned in said first seat and rigidly fixed to said rotating supporting shaft a rotating moving contact which is connected to said supporting structure by a first pivot and which is free to rotate with respect to said supporting structure in a rotation plane substantially perpendicular to a rotation axis of said rotating supporting shaft; wherein said rotating moving contact comprises an elongated body provided with an active surface that can be coupled to/uncoupled from said fixed contact by rotation of said moving contact in said rotation plane; wherein said active surface is positioned at a first operative end of said elongated body and at least partially protrudes from said supporting structure and from said first seat; wherein said elongated body is connected to said first pivot at an intermediate point between said first operative end and a second operative end of said elongated body; an elastic element suitable to ensure an adequate contact pressure when the active surface of the moving contact is coupled to said fixed contact, said elastic element having a first operative end connected to said supporting structure by a second pivot, and a second operative end; and a mechanical link comprising a first lever and a second lever, wherein the first lever has a first operative end connected to said supporting structure by a third pivot and a second operative end; wherein the second lever has a first operative end connected to the second operative end of said elongated body by a fourth pivot, and a second operative end; wherein the second operative ends of said first and second levers are connected each other by a fifth pivot; and wherein the second operative end of said elastic element is also connected to said fifth pivot.

For the purposes of the present disclosure, the terms “first end” and “second end” of a certain component (e.g., the elongated body of the rotating moving contact, the elastic element, the levers of the mechanical link) are not meant to designate the physical limits of the relevant component but the operational points of said component in which the designated functions are carried out.

As better explained in the following description, the low voltage contacts group as disclosed herein allows avoiding, or at least greatly reducing, the above-mentioned problems.

In practice, as better described hereinafter, it has been seen that the particular design and structure of the rotating moving contact sub-assembly provide an efficient system for controlling the torque exerted by the elastic element during operation, in particular during the opening movement of the rotating moving contact from the closed and pressed position to the full repulsion position. At the same time, the elastic element ensures an adequate contact pressure between the active surface of the rotating moving contact and the fixed contact when the circuit is closed.

Moreover, in this way—as better described in the following detailed description—the friction phenomena and the consequent wearing problems of certain known solution can be substantially avoided since the levers forming the mechanical link between the elastic element, the supporting structure, and the elongated body of the rotating moving contact are substantially free of friction.

It has also to be noted that by properly designing the levers of the mechanical link it is possible to optimize the torque profile exerted by the elastic element on the rotating moving contact during the opening operation under repulsion. In particular, when desired, the direction of the torque exerted by the elastic element on the rotating moving contact can be inverted at a certain point of the opening operation so that in the full repulsion position the movable contact is kept in the open position preventing its bouncing back toward the fixed contact and the possible restrike of an electrical arc.

At the same time, the relatively simple design of the mechanical link allows obtaining a very compact overall design of the movable contact assembly, thereby reducing the space required for housing the contact group in the casing of the low-voltage circuit breaker.

In a typical embodiment of the low voltage contacts group, according to the present disclosure, the supporting structure of the rotating moving contact sub-assembly may advantageously comprise a first and a second lateral walls which are substantially parallel to each other and to the rotation plane of said rotating moving contact.

In such a case, in a particular embodiment of the presently disclosed low voltage contacts group, the elongated body of the rotating moving contact and the elastic element may be advantageously housed at least partially in an internal volume which is defined by said first and a second lateral walls.

Moreover, in a typical embodiment of a low voltage contacts group better described in the following detailed description, the first operative end of said first lever may be connected to said first lateral surface by said third pivot. Then, the mechanical link of the rotating moving contact sub-assembly may comprise a third lever and a fourth lever. The third lever may be advantageously provided with a first operative end connected to said second lateral surface by said third pivot, and with a second operative end; at the same time, the fourth lever may be advantageously provided with a first operative end connected to the second operative end of said elongated body by said fourth pivot, and with a second operative end; moreover, in this embodiment of the present disclosure, the second operative ends of said third and fourth levers may be advantageously connected to each other and with the second operative ends of said first and second levers by said fifth pivot, while said second and fourth levers may be advantageously connected to the second operative end of said elongated body on opposite sides of said elongated body.

In some embodiments of the low voltage contacts group, according to the present disclosure, said first, second, third, fourth, and fifth pivots are substantially perpendicular to the rotation plane of said rotating moving contact.

In some embodiments of the low voltage contacts group, according to the present disclosure, said first and second levers have a curved profile.

For instance, in an exemplary embodiment of the low voltage contacts group of the present disclosure, said first and second levers may advantageously have a concavity which is directed toward the first operative end of said elastic element.

In embodiments of the low voltage contacts group, according to the present disclosure, the elastic element of the rotating moving contact sub-assembly may comprise, e.g., a spring. However, other elastic components performing the functions of a spring may be used.

In embodiments of the low voltage contacts group, according to the present disclosure, the elongated body of the rotating moving contact is generally movable with respect to said supporting structure between a contact position and a repulsion position.

In such a case, as better described hereinafter, the torque generated by the elastic element of the rotating moving contact sub-assembly advantageously opposes the rotation of said elongated body from the contact position to the repulsion position at least during an initial phase of said rotation.

In particular, in some embodiments, the torque generated by said elastic element may decrease during the rotation of said elongated body from the contact position to the repulsion position.

In some embodiments of the low voltage contacts group, according to the present disclosure, during the rotation of the elongated body of the rotating moving contact from the contact position to the repulsion position said fourth pivot does not cross the axis between the first and fifth pivot.

In another particular embodiment of the low voltage contacts group, according to the present disclosure, the torque generated by the elastic element of the rotating moving contact sub-assembly may oppose the rotation of the elongated body of the rotating moving contact from the contact position to the repulsion position at least during an initial phase of said rotation, and may assist the rotation of said elongated body from the contact position to the repulsion position during a final phase of said rotation.

In practice, according to this embodiment, in the full repulsion position the movable contact is kept in the open position preventing its bouncing back toward the fixed contact and the re-closure of the contacts with possible restrike of an electrical arc.

In particular, in some embodiments of the low voltage contacts group of the present disclosure, during the rotation of said elongated body from the contact position to the repulsion position said fourth pivot crosses the axis between the first and fifth pivot.

In a further aspect, the present disclosure also relates to a low voltage circuit breaker, in particular a Molded Case Circuit Breaker, comprising a low voltage contacts group as disclosed herein.

### BRIEF DESCRIPTION OF DRAWINGS

Further features and advantages of the present disclosure will be more clear from the description of some embodiments of the low voltage contacts group of the present disclosure, shown by way of examples in the accompanying drawings.

FIG. 1 is a perspective view of a low voltage circuit breaker, in particular a Molded Case Circuit Breaker, according to the present disclosure.

FIG. 2 is an exploded view of the Molded Case Circuit Breaker represented in FIG. 1.

FIG. 3 is an exploded view of some particulars of the Molded Case Circuit Breaker represented in FIG. 1, showing a low voltage contacts group, according to the present disclosure.

FIG. 4 is an exploded view of a movable contact assembly of a low voltage contact groups, according to the present disclosure.

FIG. 5 is a perspective view of a rotating moving contact sub-assembly of a movable contact assembly of a low voltage contacts group, according to the present disclosure.

FIG. 6 is an exploded view of the rotating moving contact sub-assembly represented in FIG. 5.

FIG. 7 is a section view of the rotating moving contact sub-assembly represented in FIG. 5.

FIG. 8a is a section view of a first embodiment of a low voltage contacts group, according to the present disclosure, shown in the open position.

FIG. 8b is a section view of a first embodiment of a low voltage contacts group, according to the present disclosure, shown while the contact is first approaching the closed position.

FIG. 8c is a section view of a first embodiment of a low voltage contacts group, according to the present disclosure, shown in the contact and pressed position (closed and pressed position).

FIG. 8d is a section view of a first embodiment of a low voltage contacts group, according to the present disclosure, shown in the full repulsion position.

FIG. 9a is a section view of a second embodiment of a low voltage contacts group, according to the present disclosure, shown in the open position.

FIG. 9b is a section view of a second embodiment of a low voltage contacts group, according to the present disclosure, shown while the contact is first approaching the closed position.

FIG. 9c is a section view of a second embodiment of a low voltage contacts group, according to the present disclosure, shown in the contact and pressed position (closed and pressed position).

FIG. 9d is a section view of a second embodiment of a low voltage contacts group, according to the present disclosure, shown in the full repulsion position.

FIG. 10 is a diagram of the torque acting on the movable contact assembly during movement from the closed position to the position of full repulsion as a function of the angle of rotation.

### DETAILED DESCRIPTION

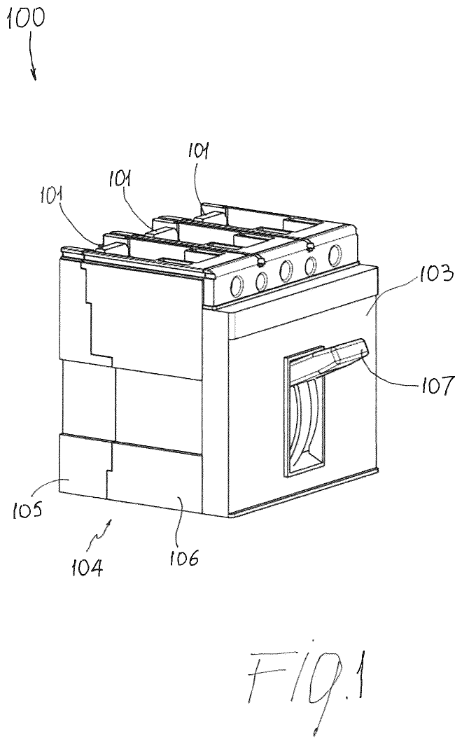

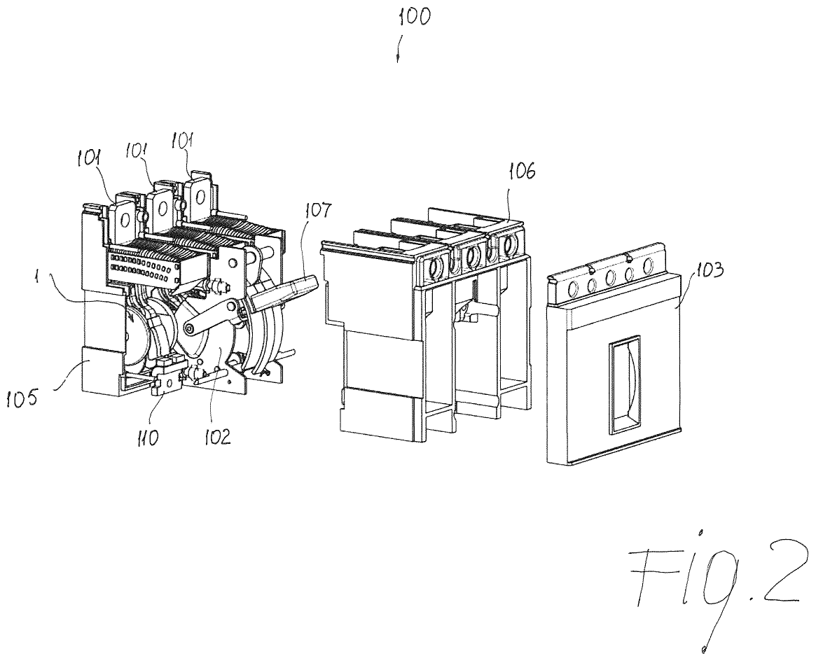

With reference to the attached figures, an example of a low-voltage circuit breaker 100, in this case a three-pole Molded Case Circuit Breaker 100, is represented in FIGS. 1 and 2. According to general embodiments and according to known solutions, the Molded Case Circuit Breaker 100 comprises a casing 104 which is divided in two parts 105 and 106 coupled together. The Molded Case Circuit Breaker 100 further comprises a front plate 103 and an operating handle 107.

For each pole, a first electrical terminal 101—connected to a fixed contact 2—and a second electrical terminal 110—connected to a moving contact 3—protrude from the casing 104 for connection of the circuit breaker with, e.g., a line and a load, according to known solution.

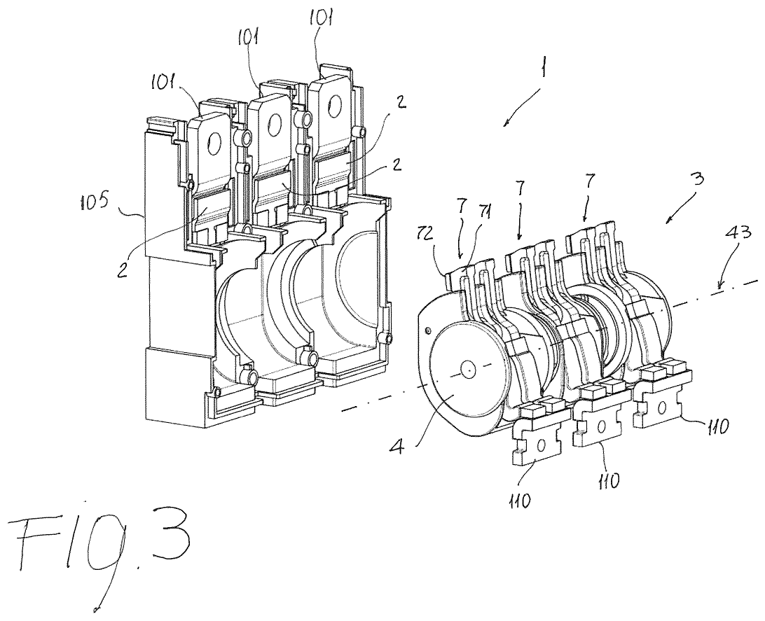

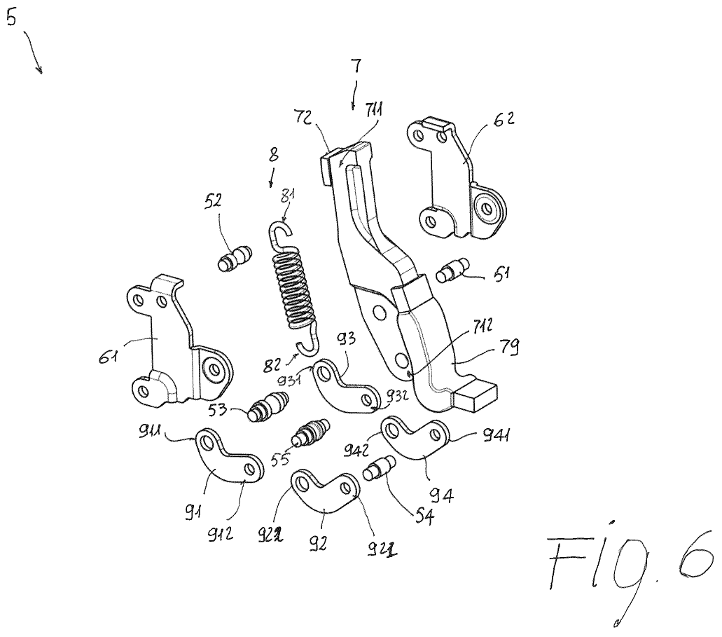

In details, with reference also to FIGS. 3-7, the Molded Case Circuit Breaker 100 comprises a contacts group 1 which, in the embodiments shown, is formed by a fixed contact 2 electrically connected to an electrical terminal 101 of the Molded Case Circuit Breaker 100, and by a movable contact assembly 3.

In turn, the movable contact assembly 3 comprises a rotating supporting shaft 4 which is operatively connected to an actuation mechanism 102 of the Molded Case Circuit Breaker 100 which is contained in the casing 106 and operatively connected to the operating handle 107. Design and principle of functioning of the actuation mechanism 102 can be those typically used in this kind of circuit breakers and therefore will not be described in further details.

The rotating supporting shaft 4 has a body 41 that is provided with a first seat 42 into which a rotating moving contact sub-assembly 5 is positioned.

In the embodiments shown, the rotating moving contact sub-assembly 5 comprises a supporting structure 6, a rotating moving contact 7, an elastic element 8, and a mechanical link 9.

In particular, the supporting structure 6 is positioned in said first seat 42 and is rigidly fixed to the rotating supporting shaft 4, so as to follow it in its rotational movement between the different operating positions. Fixing of the supporting structure 6 in the first seat 42 can be carried out, e.g., by using a pin 47 which is transversally positioned with respect to the supporting structure 6 and to the lateral walls of the first seat 42.

The rotating moving contact sub-assembly 5 further comprises a rotating moving contact 7 which is connected to the supporting structure 6 by a first pivot 51 and which is free to rotate with respect to the supporting structure 6 in a rotation plane substantially perpendicular to the rotation axis 43 of said rotating supporting shaft 4.

As shown in the attached figures, the rotating moving contact 7 comprises an elongated body 71 provided with an active (contact) surface 72 which is positioned at a first operative end 711 of the elongated body 71 and at least partially protrudes from the supporting structure 6 and from the first seat 42, so that it can be coupled to/uncoupled from the fixed contact 2 by rotation of the moving contact 7 in the above-defined rotation plane.

The elongated body 71 of the rotating moving contact 7 is electrically connected to the second electrical terminal 110 of the circuit breaker 100 through conventional means, e.g., a conductive braid 79.

Also, the elongated body 71 of the rotating moving contact 7 is mechanically connected to the supporting structure 6 by said first pivot 51 at an intermediate point between the first operative end 711 and a second operative end 712 thereof, as better defined hereinafter.

The rotating moving contact sub-assembly 5 further comprises an elastic element 8 which has the purpose to ensure an adequate contact pressure when the active (contact) surface 72 of the moving contact 7 is coupled to the corresponding fixed contact 2. From a design standpoint, the elastic element 8 has a first operative end 81 which is connected to the supporting structure 6 by a second pivot 52 and a second operative end 82 connected to the mechanical link 9 by a further pivot, as better described hereafter.

Furthermore, the rotating moving contact sub-assembly 5 comprises a mechanical link 9 which in turn comprises a first lever 91 and a second lever 92.

In particular, the first lever 91 has a first operative end 911 which is connected to the supporting structure 6 by a third pivot 53, and a second operative end 912 which is operatively connected to the second lever 92; the second lever 92 has a first operative end 921 which is connected to the second operative end 712 of the elongated body 71 by a fourth pivot 54, and a second operative end 922 which is connected to the second operative end 912 of the first lever 91 by a fifth pivot 55.

The fifth pivot 55 is also the point where the elastic element 8 is connected to the kinematic chain 9. In practice, while the first operative end 81 is fixed to the supporting structure 6 by the second pivot 52, the second operative end 82 thereof is connected to the kinematic chain 9 by the fifth pivot 55, thereby realizing an elastic connection between the supporting structure 6 and the kinematic chain 9, and consequently also with the rotating moving contact 7.

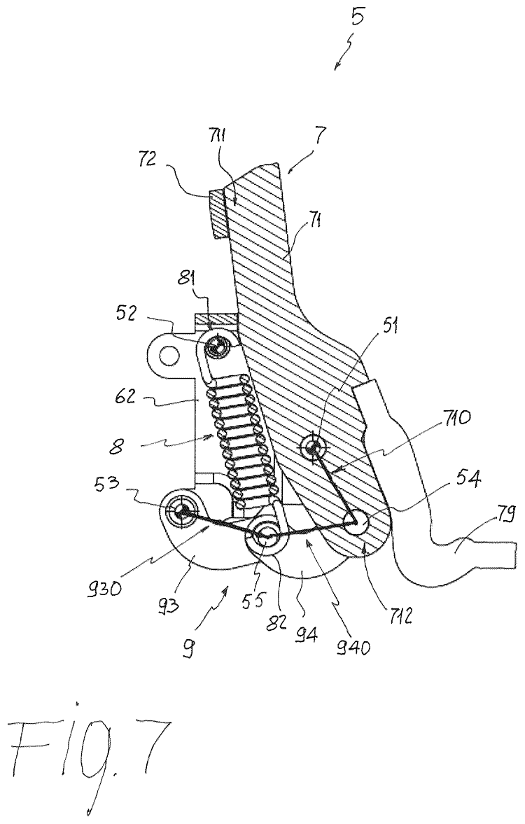

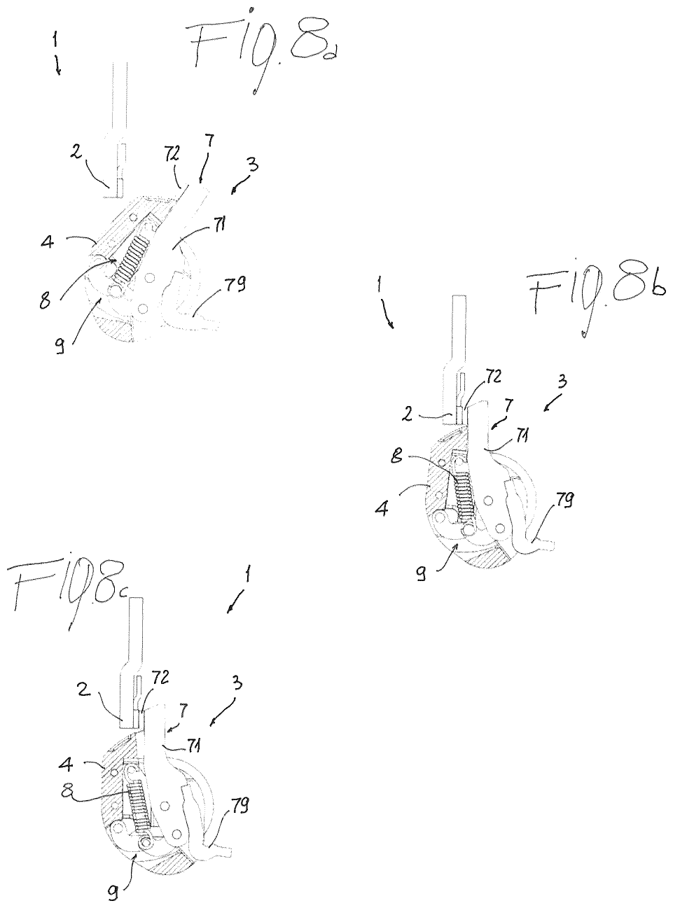

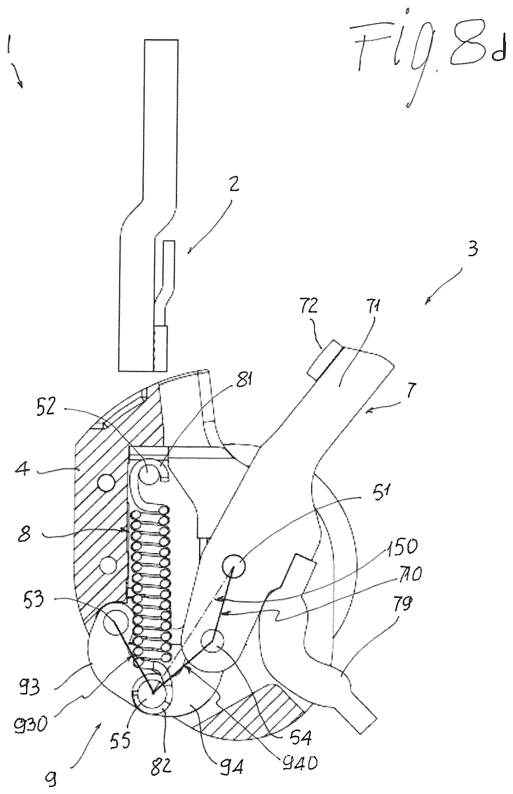

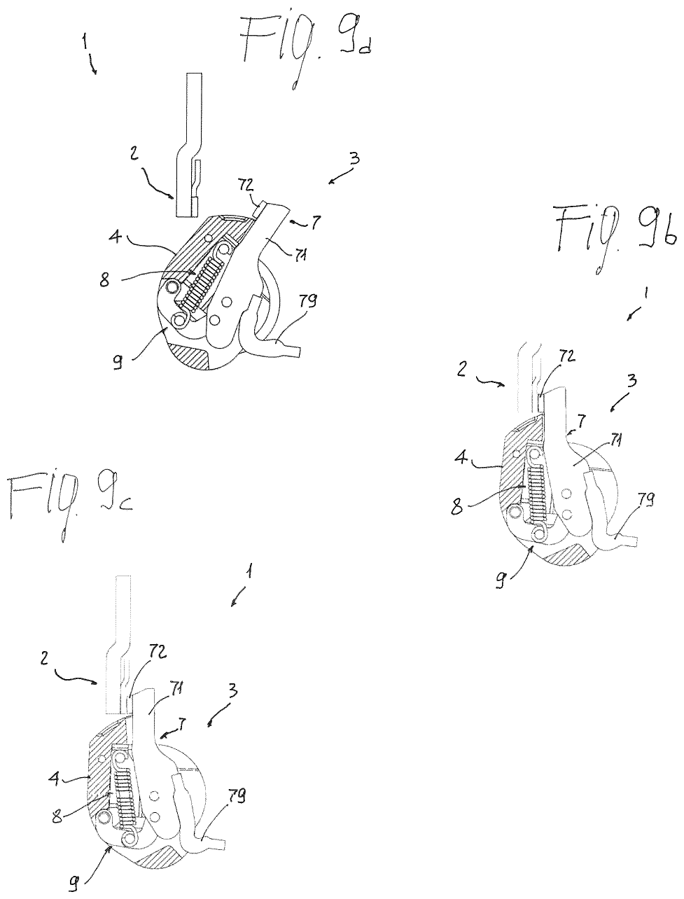

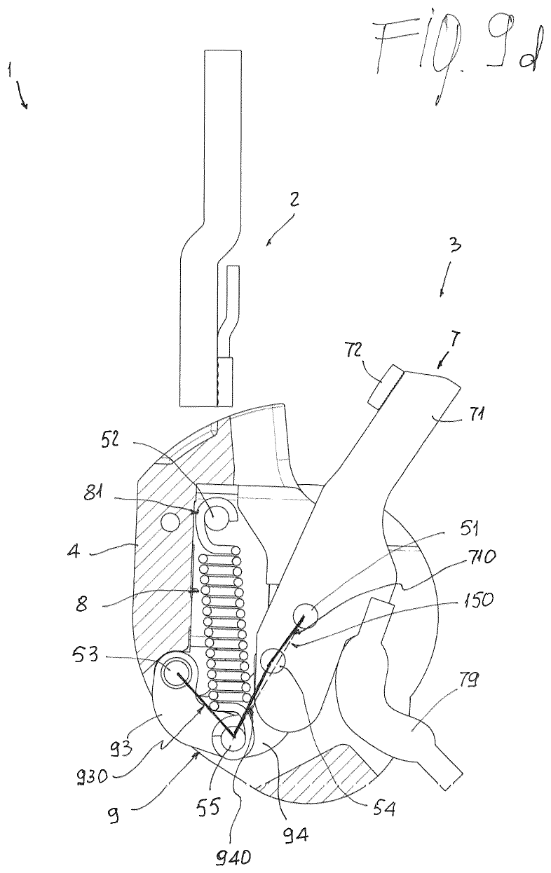

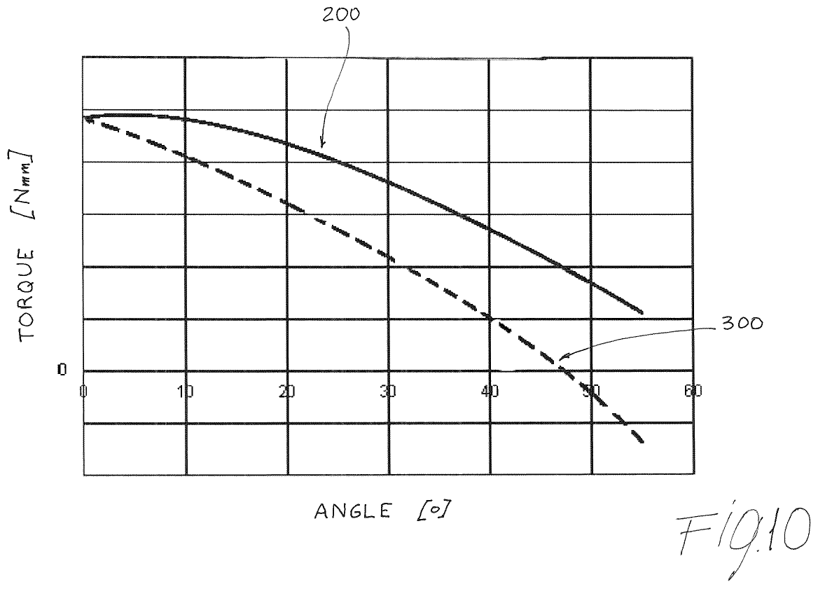

The functioning of the low voltage contacts group 1 of the present disclosure can be described with reference to FIGS. 8a-8d and 9a-9d.

Starting from the open position of FIGS. 8a and 9a, the contact system is brought in the closed position by rotating the supporting shaft 4 counterclockwise. During a first phase of the movement (FIGS. 8a-8b and 9a-9b), the whole rotating moving contact sub-assembly 5 follows the rotation of the rotating supporting shaft 4 until the closed position of FIGS. 8b and 9b is reached.

In a second phase of the movement (FIGS. 8b-8c and 9b-9c), the rotating supporting shaft 4 continues its counterclockwise movement followed by the supporting structure 6 which is rigidly fixed thereto, while the elongated body 71 of the rotating moving contact 7 remains stationary with the active (contact) surface 72 resting on the corresponding fixed contact 2. Due to the action of the elastic means 8, in the final closed and pressed position of FIGS. 8c and 9c, the desired contact pressure between the active (contact) surface 72 of the rotating moving contact 7 and the corresponding fixed contact 2 is therefore ensured.

When electrodynamic repulsion forces occur between the fixed 2 and movable 3 contacts, the elongated body 71 of the rotating moving contact 7 moves clockwise until the full repulsion position of FIGS. 8d and 9d is reached. During such movement, the torque exerted by the elastic element 8 on the rotating moving contact 7 through to the kinematic chain 9 follows the paths represented in FIG. 10, where the line 200 refers to the embodiment of FIGS. 8a-8d and the line 300 refers to the embodiment of FIGS. 9a-9d.

In other words, as clearly shown in the attached Figure, the elongated body 71 of the rotating moving contact 7 follows the movement of the supporting structure 6 and of the rotating supporting shaft 4 during the movement between the open position (FIGS. 8a and 9a) and the closed position (FIGS. 8b and 9b), remains fixed against the fixed contact 2 while the rotating supporting shaft 4 and the supporting structure 6 continue their movement to the closed and pressed position (FIGS. 8c and 9c), and is movable with respect to the supporting structure 6 and the rotating supporting shaft 4 between the contact position and the full repulsion position (FIGS. 8d and 9d).

In general, the mechanical connection between the rotating moving contact 7 and the supporting structure can be schematically represented by the segments 930, 940 and 710 which are articulated in sequence and in free rotation with respect to each other in correspondence of the pivots 54 and 55, the extremes of the sequence of segments 930, 940 and 710 being fixed in free rotation around the pivots 51 and 53.

The intermediate pivot 55 is also an intermediate point of the sequence of segments 930, 940 and 710 where the second operative end 82 of the elastic element 8 is connected to the kinematic chain 9, thereby providing the required contact pressure in the closed and pressed position (as shown in the diagram of FIG. 10 at 0° of angle of rotation of the rotating moving contact 7) and generating a torque on the elongated body 71 during the movement from the contact position to the full repulsion position (as shown in the diagram of FIG. 10 between 0° and about 55° of angle of rotation of the rotating moving contact 7).

In practice, in the embodiments shown, the force exerted by the elastic element 8 is linearly applied on the kinematic chain 9 in correspondence of the fifth pivot 55 along the direction defined by the second 52 and fifth 55 pivots, so as to provide the required contact pressures and torques.

One of the advantages of the low-voltage contacts group 1 of the present disclosure is given by the fact that it is substantially free of the friction problems which affect some of the known embodiments.

Moreover, the combination of an elastic element 8 with a mechanical link 9 based on a lever system, allows easily tailoring the performances of the low voltage contacts group 1 according to the operative needs.

Indeed, by properly selecting shape and length of the first 91 and second 92 levers, the strength of the elastic element 8, as well as the relative positioning of the various pivots 51, 52, 53, 54 and 55, it is possible to design a low voltage contacts group 1 in which the torque exerted around the rotating moving contact 3 follows a desired behavior.

In general, as shown in the diagrams of FIG. 10, the torque generated by the elastic element 8 around the rotating moving contact 3 opposes the rotation of the elongated body 71 of the rotating moving contact 7 from the contact position (at 0° of angle of rotation) to the full repulsion position (at about 55° of angle of rotation in the embodiments shown), at least during an initial phase of said rotation.

In particular, as shown in FIG. 10, in general embodiments of the presently disclosed low voltage contacts group 1, the torque generated by said elastic element 8 decreases during the rotation of the elongated body 71 from the contact position, at 0° of angle of rotation, to the repulsion position, at about 55° of angle of rotation.

As previously said, the value of the torque in the full repulsion position, as well as its direction, can be adapted according to the needs by properly selecting shape and length of the levers 91 and 92, the strength of the elastic element 8, and the relative positioning of the various pivots 51, 52, 53, 54 and 55,

Thus, in an embodiment of the present disclosure shown in FIGS. 8a-8d, the value of the torque generated by the elastic element 8 decreases during the rotation of the elongated body 71 from the contact position, at 0° of angle of rotation, to the repulsion position, at about 55° of angle of rotation and maintain the same sign, as shown by the curve 200 in the diagram of FIG. 10.

In other words, in embodiments of this kind, the torque generated by the elastic element 8 decreases during the entire rotation of the elongated body 71 of the rotating moving contact 7 and tends to rotate the elongated body 71 always in the same direction (counterclockwise in the embodiment shown in FIGS. 8a-8d), i.e., the torque generated by the elastic element 8 opposes the rotation of the elongated body 71 during the entire rotation movement from the contact position to the full repulsion position.

In particular, with reference to FIG. 8d, from a schematic standpoint the mechanically connection between the rotating moving contact 7 and the supporting structure (represented by the segments 930, 940 and 710 as previously described) is designed so that during the rotation of the elongated body 71 from the contact position to the full repulsion position, the fourth pivot 54 (joining the segment 710 with the segment 940) do not cross the axis 150 between the fifth pivot 55 (joining the segment 940 with the segment 950) and the first pivot 51 (at the extreme of the segment 710). In other words, during rotation of the rotating moving contact 7, the elongated body 71 does not “pass over” the axis represented by the segment 150 joining the pivots 51 (center of rotation of the elongated body 71) and 55 (point where the force of the elastic element is applied), and the torque keeps the same sign (i.e., imparts a counterclockwise rotation to the elongated body 71 in the embodiment shown in FIG. 8d), even if its absolute value decreases.

In an alternative embodiment of the present disclosure shown in FIGS. 9a-9d, the value of the torque generated by the elastic element 8 still decreases during the rotation of the elongated body 71 from the contact position (at 0° of angle of rotation) to the repulsion position (at about 55° of angle of rotation), but it changes the sign when the elongated body 71 is close to the full repulsion position, as shown by the curve 300 in the diagram of FIG. 10.

As in the previous case, also in embodiments of this kind the torque generated by the elastic element 8 decreases during the entire rotation of the elongated body 71 of the rotating moving contact 7. However, differently from the previous case, the torque generated by the elastic element 8 opposes the rotation of the elongated body 71 from the contact position to the repulsion position only during a first phase of said rotation (e.g., until when the elongated body 71 is at a few degrees of rotation from the full repulsion position), and then assists the rotation of the elongated body 71 during a final phase of said rotation.

In other words, in the embodiment shown in FIGS. 9a-9d, the torque generated by the elastic element 8 tends to rotate the elongated body 71 in one direction (i.e., counterclockwise in the embodiment shown) during a first phase of the rotation, and in the opposite direction (i.e., clockwise in the embodiment shown) in the final phase of the rotation, thereby keeping the elongated body 71 of the rotating moving contact 7 latched in the full repulsion position and avoiding re-closure of the contacts.

In particular, with reference to FIG. 9d, from a schematic standpoint the mechanically connection between the rotating moving contact 7 and the supporting structure (represented by the segments 930, 940 and 710 as previously described) is designed so that during the rotation of the elongated body 71 from the contact position to the full repulsion position, the fourth pivot 54 (joining the segment 710 with the segment 940) crosses the axis 150 between the fifth pivot 55 (joining the segment 940 with the segment 950) and the first pivot 51 (at the extreme of the segment 710). In other words, during rotation of the rotating moving contact 7, the elongated body 71 do “pass over” the axis represented by the segment 150 joining the pivots 51 (center of rotation of the elongated body 71) and 55 (point where the force of the elastic element is applied), and the torque changes its sign (i.e., imparts a clockwise rotation to the elongated body 71 in the embodiment shown in FIG. 9d), thereby avoiding re-closure of the contacts.

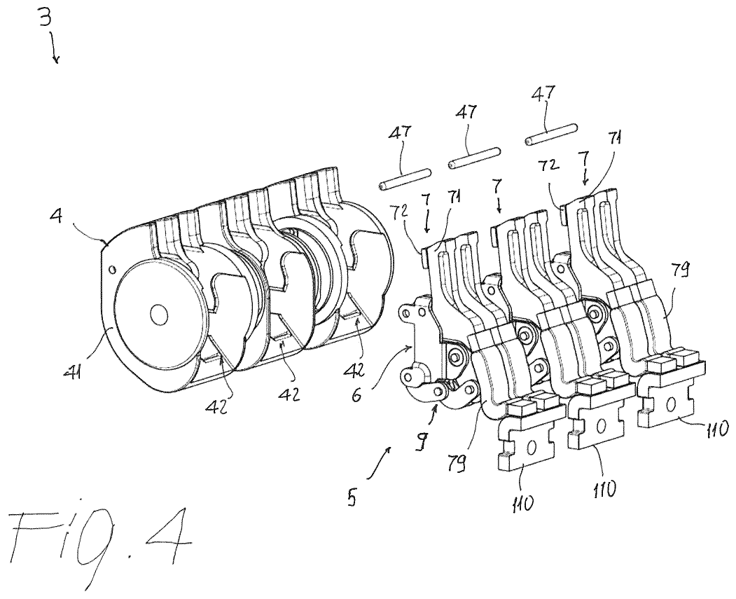

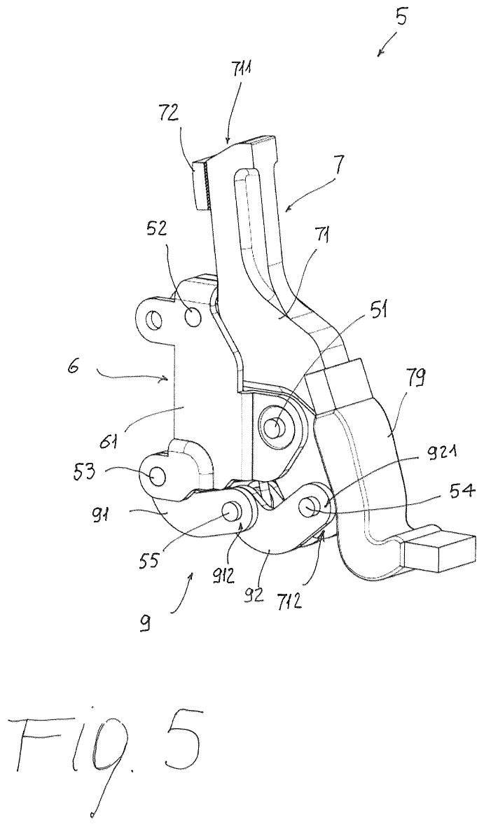

With particular reference to FIGS. 5 and 6, from a structural standpoint, in some embodiments of the low voltage contacts group 1 of the present disclosure, the supporting structure 6 of the rotating moving contact sub-assembly 5 advantageously comprises a first 61 and a second 62 lateral walls which are substantially parallel to each other and to the rotation plane of said rotating moving contact 7.

The first 61 and the second 62 lateral walls of the supporting structure 6 are positioned in the first seat 42 of the body 41 of the rotating supporting shaft 4 and are rigidly fixed to it by using a pin 47 which is transversally positioned with respect to the first 61 and second 62 lateral walls of the supporting structure 6 and as well as to the lateral walls of the first seat 42 of the rotating supporting shaft 4.

As shown in particular in FIGS. 4-7—in embodiments of this kind—the elongated body 71 of the rotating moving contact 7 and the elastic element 8 are at least partially housed in an internal volume which is defined between the first 61 and second 62 lateral walls of the supporting structure 6.

With reference to FIGS. 5 and 6, in particular embodiments of the low voltage contacts group 1 of the present disclosure, the mechanical link 9 comprises two pairs of levers which are positioned on opposite sides of the elongated body 71 of the rotating moving contact 7.

In practice, in addition to the first 91 and second 92 levers as previously described, the mechanical link 9 also comprises a third lever 93 and a fourth lever 94 which are positioned on opposite sides of the elongated body 71 of the rotating moving contact 7, mirroring the positions of the first 91 and second 92 levers.

In these embodiments, the first operative end 911 of the first lever 91 is connected to the first lateral surface 61 of the supporting structure 6 through the third pivot 53, while the third lever 93 has a first operative end 931 which is connected to the second lateral surface 62 of the supporting structure 6 through the same third pivot 53. In other words, the first 91 and second 92 levers are respectively connected to the first 61 and second 62 lateral surface of the supporting structure 6 on opposite sides of the elongated body 71 of the rotating moving contact 7 by using the same third pivot 53.

The fourth lever 94 has a first operative end 941 which is connected to the second operative end 712 of said elongated body 71 through the same fourth pivot 54 which connects the first operative end 921 of the second lever 92 to the second operative end 712 of the elongated body 71. In practice, the second 92 and fourth 94 levers are connected to the second operative end 712 of the elongated body 71 of the rotating moving contact 7 on opposite sides of said elongated body 71 by using the same fourth pivot 54.

The third lever 93 has a second operative end 932 and the fourth lever 94 has a second operative end 942 which is operatively connected to the second operative end 932 of the third lever 93. In particular, the second operative ends 932 and 942 of said third 93 and fourth 94 levers are connected to each other and with the second operative ends 912 and 922 of the first 91 and second 92 levers through the same fifth pivot 55.

The fifth pivot 55 is also the point where the second operative end 82 of the elastic element 8 is connected to the kinematic chain 9, thereby transmitting the required force to both pairs of levers systems 91; 92 and 93; 94.

In general, said first 51, second 52, third 53, fourth 54, and fifth 55 pivots can be constituted by properly shaped pins which are substantially perpendicular to the rotation plane of said rotating moving contact 7

According to a simple but effective design of the low voltage contacts group 1 of the present disclosure, the elastic element 8 may comprise a spring. For instance, the elastic element 8 may be a linear spring having a first extreme 81 which is fixed on the supporting structure 6, e.g., on both the first 61 and second 62 lateral surfaces of the supporting structure 6, through the second pivot 52, and a second extreme 82 which is fixed to the kinematic chain 9 through the fifth pivot 55. In practice, in general kinds of embodiments, the elastic element 8 rotates around the second pivot 52 and linearly acts along the direction defined by the axis joining the second pivot 52 with the fifth pivot 55, thereby imparting the required force at an intermediate point of the articulated system schematically represented by the sequence of segments 930, 940 and 710.

The value and the direction of the torque resulting on the rotating moving contact sub-assembly 5 can therefore be designed by properly selecting length and shape of the levers forming the kinematic chain 9, the position of the pivot points 51-55, as well as the strength of the elastic element 8.

For instance, in the embodiments of the low voltage contacts group 1 shown in the attached Figures, the first 91 and second 92 levers (and when present, also the third 93 and fourth 94 levers) have a curved profile.

In particular, said levers advantageously have a curved profile with a concavity directed toward the first operative end 81 (e.g., the pivot point 52) of said elastic element 8.

Other kinds of design are however possible and can be easily determined by considering the schematic single line diagram of the articulated system represented by the sequence of segments 930, 940 and 710 onto which the force of the elastic element 8 is applied at an intermediate point thereof.

In the embodiments of FIGS. 5 and 6, a rotating moving contact sub-assembly 5 having a single rotating moving contact 7 is shown, while in FIGS. 2-4, a contact system having, for each pole, a pair of rotating moving contact sub-assembly 5 and a corresponding pair of rotating moving contact 7 electrically connected in parallel is shown. In practice, the system of the present disclosure can be used in different kinds of circuit breakers based on different kinds of interruption design.

In general, a low voltage circuit breaker 100, in particular a Molded Case Circuit Breaker, comprising a low voltage contacts group 1 as described herein is also part of the present disclosure.

It is clear from the above that the low voltage contact group of the present disclosure allows solving the previously underlined technical problems.

Several variations can be made to the low voltage contact group thus conceived, all falling within the scope of the attached claims. In practice, the materials used and the contingent dimensions and shapes can be any, according to requirements and to the state of the art.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A low-voltage contacts group for a low-voltage circuit breaker comprising:
a fixed contact configured to be electrically connected to an electrical terminal of the circuit breaker; and
a movable contact assembly comprising:
a rotating supporting shaft configured to be operatively connected to an actuation mechanism of the circuit breaker and which has a body provided with a first seat; and
a rotating moving contact sub-assembly comprising:
a supporting structure positioned in the first seat and rigidly fixed to the rotating supporting shaft;
a rotating moving contact which is connected to the supporting structure by a first pivot and which is free to rotate with respect to the supporting structure in a rotation plane substantially perpendicular to a rotation axis of the rotating supporting shaft; wherein the rotating moving contact comprises an elongated body provided with an active surface that can be coupled to/uncoupled from the fixed contact by rotation of the moving contact in the rotation plane; wherein the active surface is positioned at a first operative end of the elongated body and at least partially protrudes from the supporting structure and from the first seat; wherein the elongated body is connected to the first pivot at an intermediate point between the first operative end and a second operative end of the elongated body;
an elastic element suitable to ensure an adequate contact pressure when the active surface of the moving contact is coupled to the fixed contact, the elastic element having a first operative end connected to the supporting structure by a second pivot, and a second operative end; and
a mechanical link comprising a first lever and a second lever, wherein the first lever has a first operative end connected to the supporting structure by a third pivot and a second operative end; wherein the second lever has a first operative end connected to the second operative end of the elongated body by a fourth pivot, and a second operative end; wherein the second operative ends of the first and second levers are connected each other by a fifth pivot; and wherein the second operative end of the elastic element is also connected to the fifth pivot.

2. The low voltage contacts group, according to claim 1, wherein the supporting structure comprises a first and a second lateral walls substantially parallel to each other and to the rotation plane of the rotating moving contact.

3. The low voltage contacts group, according to claim 2, wherein the elongated body of the rotating moving contact and the elastic element are at least partially housed in an internal volume defined by the first and second lateral walls.

4. The low voltage contacts group, according to claim 2, wherein the first operative end of the first lever is connected to the first lateral surface by the third pivot; and wherein the mechanical link comprises a third lever and a fourth lever; wherein the third lever has a first operative end connected to the second lateral surface by the third pivot, and a second operative end; wherein the fourth lever has a first operative end connected to the second operative end of the elongated body by the fourth pivot, and a second operative end; wherein the second operative ends; of the third and fourth levers are connected each other and with the second operative ends of the first and second levers by the fifth pivot; and wherein the second and fourth levers are connected to the second operative end of the elongated body on opposite sides of the elongated body.

5. The low voltage contacts group, according to claim 1, wherein the first, second, third, fourth, and fifth pivots are substantially perpendicular to the rotation plane of the rotating moving contact.

6. The low voltage contacts group, according to claim 1, wherein the first and second levers have a curved profile.

7. The low voltage contacts group, according to claim 6, wherein the first and second levers have a concavity directed toward the first operative end of the elastic element.

8. The low voltage contacts group, according to claim 1, wherein the elastic element comprises a spring.

9. The low voltage contacts group, according to claim 1, wherein the elongated body is movable with respect to the supporting structure between a contact position and a repulsion position.

10. The low voltage contacts group, according to claim 9, wherein the torque generated by the elastic element opposes the rotation of the elongated body from the contact position to the repulsion position at least during an initial phase of the rotation.

11. The low voltage contacts group, according to claim 9, wherein the torque generated by the elastic element decreases during the rotation of the elongated body from the contact position to the repulsion position.

12. The low voltage contacts group, according to claim 9, wherein the torque generated by the elastic element opposes the rotation of the elongated body from the contact position to the repulsion position at least during an initial phase of the rotation, and assists the rotation of the elongated body from the contact position to the repulsion position during a final phase of the rotation.

13. The low voltage contacts group, according to claim 9, wherein during the rotation of the elongated body from the contact position to the repulsion position, the fourth pivot does not cross the axis between the first and fifth pivot.

14. The low voltage contacts group, according to claim 12, wherein during the rotation of the elongated body from the contact position to the repulsion position, the fourth pivot crosses the axis between the first and fifth pivot.

15. A low voltage circuit breaker, comprising a low voltage contacts group, the low voltage contacts group comprising:
a fixed contact configured to be electrically connected to an electrical terminal of the circuit breaker; and
a movable contact assembly comprising:
a rotating supporting shaft configured to be operatively connected to an actuation mechanism of the circuit breaker and which has a body provided with a first seat; and
a rotating moving contact sub-assembly comprising:
a supporting structure positioned in the first seat and rigidly fixed to the rotating supporting shaft;
a rotating moving contact which is connected to the supporting structure by a first pivot and which is free to rotate with respect to the supporting structure in a rotation plane substantially perpendicular to a rotation axis of the rotating supporting shaft; wherein the rotating moving contact comprises an elongated body provided with an active surface that can be coupled to/uncoupled from the fixed contact by rotation of the moving contact in the rotation plane; wherein the active surface is positioned at a first operative end of the elongated body and at least partially protrudes from the supporting structure and from the first seat; wherein the elongated body is connected to the first pivot at an intermediate point between the first operative end and a second operative end of the elongated body;
an elastic element suitable to ensure an adequate contact pressure when the active surface of the moving contact is coupled to the fixed contact, the elastic element having a first operative end connected to the supporting structure by a second pivot, and a second operative end; and
a mechanical link comprising a first lever and a second lever, wherein the first lever has a first operative end connected to the supporting structure by a third pivot and a second operative end; wherein the second lever has a first operative end connected to the second operative end of the elongated body by a fourth pivot, and a second operative end; wherein the second operative ends of the first and second levers are connected each other by a fifth pivot; and wherein the second operative end of the elastic element is also connected to the fifth pivot,
wherein the low-voltage contacts group is enclosed within a casing.

16. The low voltage circuit breaker of claim 15, wherein the low voltage circuit breaker is a molded case circuit breaker.
